(19) United States
(12) Patent Application Publication
(10) Pub. No.: US 2024/0418234 A1
(43) Pub. Date: Dec. 19, 2024

(54) Vibration Damper With A Connection To A Hydraulic System

(71) Applicant: ZF Friedrichshafen AG, Friedrichshafen (DE)

(72) Inventors: Rainer BEILNER, Bergrheinfeld (DE); Matthias REUSS, Werneck (DE)

(73) Assignee: ZF Friedrichshafen AG, Friedrichshafen (DE)

(21) Appl. No.: 18/708,450

(22) PCT Filed: Nov. 11, 2022
(86) PCT No.: PCT/EP2022/081566

§ 371 Date: May 8, 2024

(30) Foreign Application Priority Data
Nov. 18, 2021 (DE) 10 2021 212 966.8

(51) Int. Cl. F16F 9/43; F16F 9/18; F16F 9/32; F16F 9/50

(52) U.S. Cl. CPC F16F 9/43; F16F 9/185; F16F 9/3242; F16F 9/50; F16F 9/3271; F16F 2222/12; F16F 2228/066; F16F 2230/0005

(57) ABSTRACT

A vibration damper (1), having a cylinder (3) in which a piston (7) on a piston rod (5) separates a working chamber on the piston rod side (13) from a working chamber remote from the piston rod (15), wherein both working chambers (13, 15) are connected, via fluid lines (23, 27) within a line block (19) connected to the cylinder (3), to at least one adjustable damping valve device (25, 29) and to a hydraulic system (81) connectable to at least one connection opening (85, 87) of the line block (19), wherein the line block (19) has at least one randomly actuatable check valve (97, 99) for a volume flow rate through the connection opening (85, 87).

### PRIORITY CLAIM

This is a U.S. national stage of application No. PCT/EP2022/081566, filed on Nov. 11, 2022. Priority is claimed on German Application No. 10 2021 212 966.8, filed Nov. 18, 2021, the content of which is incorporated herein by reference.

### FIELD OF THE INVENTION

The invention relates to a vibration damper for connection to a hydraulic system.

### DISCUSSION OF RELATED ART

DE 10 2019 206 455 A1 discloses a vibration damper which has, for optimization of the spatial arrangement, a line block arranged at one end, said line block comprising a line system for connecting a working chamber on the piston rod side and a working chamber remote from the piston rod to one adjustable damping valve device each.

This design of a vibration damper can also be connected to a hydraulic system, if the line block is designed according to FIG. 7.

The design according to FIG. 7 of DE 10 2019 206 455 A1 becomes problematic in particular if the vibration damper and the hydraulic system are assembled separately and are only connected to one another in the vehicle. During the vehicle assembly, the vibration damper cannot be filled within the usual time interval. The equipment expenditure would be much too high.

Simple check valves in the connection openings for the hydraulic system would not be expedient, because pressurized damping medium flows through the corresponding channels in two directions during operation of the vibration damper. Consequently, the check valves could inadvertently be closed during the operation of the vibration damper.

### SUMMARY OF THE INVENTION

It is an object of the present disclosure to provide the vibration damper with a connection possibility for a hydraulic system, such that the problem known from the prior art is solved.

The object is achieved by virtue of the fact that the line block has at least one shut-off valve, which can be actuated in any way, for a volumetric flow through the connection opening.

With the at least one shut-off valve, it is possible to completely produce the vibration damper like other conventional vibration dampers, i.e. with a damping medium filling which, if necessary, is also pressurized. The closed unit can be delivered to the assembly site, mechanically connected to the hydraulic system, and subsequently opened so that there is also a hydraulic connection.

In another advantageous embodiment, the at least one shut-off valve and the at least one adjustable damping valve device are arranged axially on different planes. The advantage is that, because of this design, there is better access to the shut-off valves in a narrow wheelhouse of a vehicle to adjust said shut-off valves from the blocking position to the passage position.

With a view to minimal production complexity, in particular machining complexity, the at least one shut-off valve and the at least one adjustable damping valve device are connected to a common fluid channel.

According to an advantage, the at least one fluid channel to the shut-off valve is oriented eccentrically with respect to the longitudinal axis of the vibration damper. As a result, greater installation space is available for the at least one shut-off valve.

An additional measure for optimizing the accessibility of the shut-off valve, in particular in the vehicle, is that the longitudinal axes of the at least one shut-off valve and of the at least one adjustable damping valve device cross one another.

To optimize the manufacturability of the line block, it is provided, inter alia, that the connection opening for the hydraulic system and the at least one shut-off valve have a common angular orientation within the vibration damper. For example, machining work for producing the connection geometry for the hydraulic system and for producing the receiving geometry for the shut-off valve can be performed in one machine setup.

With a view to a very simple and reliable design of the shut-off valve, the shut-off valve has a connection chamber, which is connected to the fluid line in the line block and to the connection opening for the hydraulic system, the connection chamber having a valve seat surface for a valve body of the shut-off valve. Just a small adjustment travel of the valve body leads to a large flow cross section, and therefore the opening movement of the shut-off valve can proceed very quickly.

Another advantage is that a receiving chamber of the shut-off valve, said receiving chamber being located behind the connection chamber, is connected to the atmosphere. By means of the shut-off valve, air can also be removed from the vibration damper with the hydraulic system.

The shut-off valve is oriented horizontally with respect to the longitudinal axis of the vibration damper so that the excitations acting on the vibration damper do not put the shut-off valve into an undefined operating position.

### BRIEF DESCRIPTION OF THE DRAWINGS

In the drawings:

FIGS. 1 and 2 show a longitudinal section through a vibration damper according to the invention;

FIGS. 3 and 4 show height sections through the vibration damper according to FIGS. 1 and 2;

FIG. 5 shows a line block of the vibration damper according to FIGS. 1 and 2;

FIGS. 6-8 show sectional views of the line block according to FIG. 5.

### DETAILED DESCRIPTION OF THE PRESENTLY PREFERRED EMBODIMENTS

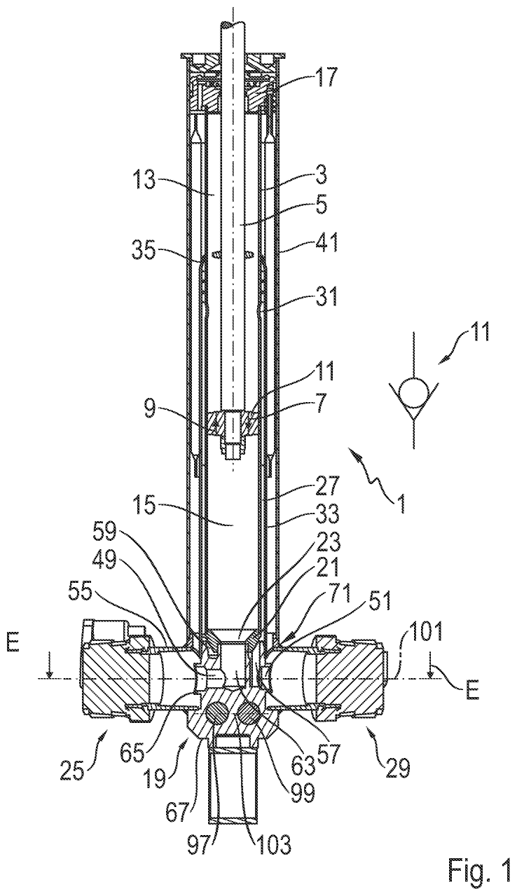

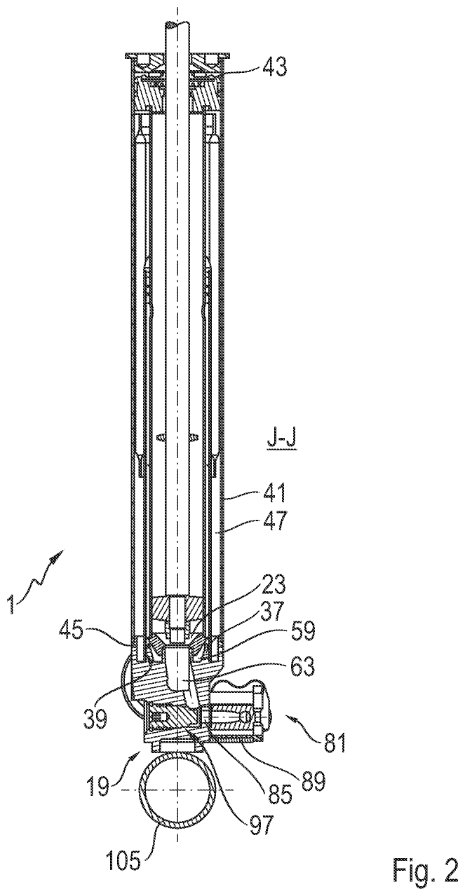

FIGS. 1 and 2 show a longitudinal section through a vibration damper 1 having a cylinder 3, in which an axial movable piston rod 5 with a piston 7 is guided. Flow through the piston 7 is possible on both sides, via damping valves 9; 11, and the piston divides the cylinder 3 into a working chamber 13 on the piston rod side and a working chamber 15 remote from the piston rod. Both working chambers are completely filled with a hydraulic damping medium.

The working chamber 13 on the piston rod side is closed at an end thereof by a piston rod guide 17. At the other end of the cylinder 3, a line block 19 is arranged in line with the cylinder 3 and a funnel-shaped reducing piece 21 is arranged between the cylinder 3 and the line block 19. The reducing piece 21 provides, for the working chamber 15 remote from the piston rod, a ring bottom having a first fluid connection 23 to an adjustable damping valve device 25. In this variant, the reducing piece 21 is formed by a component separate from the line block 19, in particular in order to simplify the manufacturability of the line block 19. In principle, the reducing piece could also be a fixed part of the wall of the cylinder 3, i.e. integral with or welded to the cylinder 3.

The working chamber 13 on the piston rod side is connected, via a second fluid connection 27, to a second damping valve device 29. The second fluid connection 27 is connected to the working chamber 13 on the piston rod side via a connection opening 31 within the piston rod guide 17 or in a region of the cylinder 3 which the piston 7 does not traverse.

The cylinder 3 is enclosed by an intermediate tube 33, a connection region 35 of which is positioned radially on the cylinder 3. An annular chamber between the intermediate tube 33 and an outer lateral surface of the cylinder 3 forms the longest portion of the second fluid connection 27.

At its other end, the intermediate tube 33 is centered and held by a stub 37 of the line block 19 (FIG. 2).

The cylinder 3 and the intermediate tube 33 are enclosed, in turn, by an outer container tube 41. The container tube 41 extends at least from an outer end face 43 of the piston rod guide 17 to a centering protrusion 45 of the line block 19. Therefore, the line block 19 forms an end closure for the entire vibration damper 1.

An annular chamber between the intermediate tube 33 and an inner wall of the container tube 41 forms a compensation chamber 47, which is only partly filled with damping medium, and which compensates for the damping medium volume displaced by the piston rod 5 from the working chambers 13; 15 of the cylinder 3. Both adjustable damping valve devices 25; 29 are connected, in the outflow direction, to the common compensation chamber 47.

The second fluid connection 27 is likewise connected to the line block 19, and the two fluid connections 23; 27 each have a separate radial channel 49; 51 within the line block 19, said radial channels being connected to inlet openings (not shown) of the respective damping valve devices 25; 29. With respect to the structure and function of the two damping valve devices 25; 29, which are structurally identical, reference is made, by way of example, to DE 10 2013 218 658 A1.

A longitudinal portion 57 of the second fluid connection 27 runs within the line block 19. The reducing piece 21 separates an annular chamber 59 within the second fluid connection 27 in the region of an end face 61 of the line block 19 from the working chamber 15 remote from the piston rod. This annular chamber 59 forms a radial transition within the second fluid connection 27 in the region of the outer lateral surface of the cylinder 3 and the axial longitudinal portion 57 of the second fluid connection 27 within the line block 19. The radial channel 51 for the damping valve device 29 of the working chamber 13 on the piston rod side is connected to said axial longitudinal portion 57.

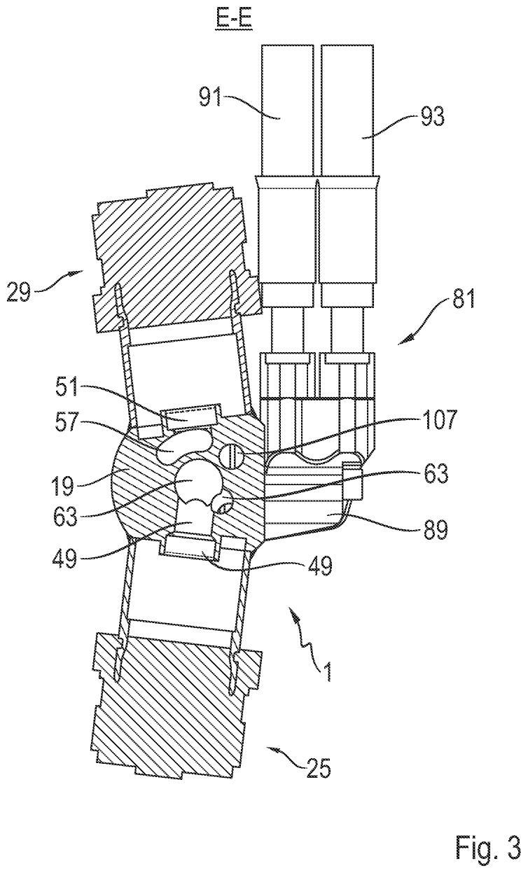

A longitudinal portion 63 of the first fluid connection 23 runs concentrically within the line block 19 (FIG. 3). Said longitudinal portion 63 holds the reducing piece 21 and has the radial channel 49 connected to a connection stub 65 for the damping valve device 25 for the working chamber 15 remote from the piston rod. The two radial channels 49; 51 have an axial overlap; in this specific exemplary embodiment, the two damping valve devices 25; 29 even have an identical axial distance from a terminal end face 67 of the line block 19. Owing to the annular space 59, the longitudinal portion 57 can be shifted radially inward with respect to the longitudinal portion 63, and as a result the distance of the connection stubs 65; 69 for the two damping valve devices 25; 29 can also be minimized.

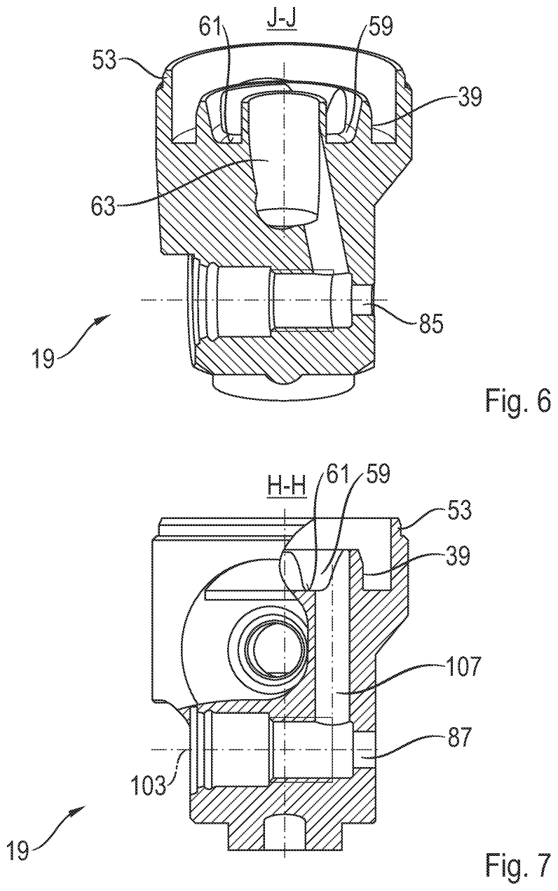

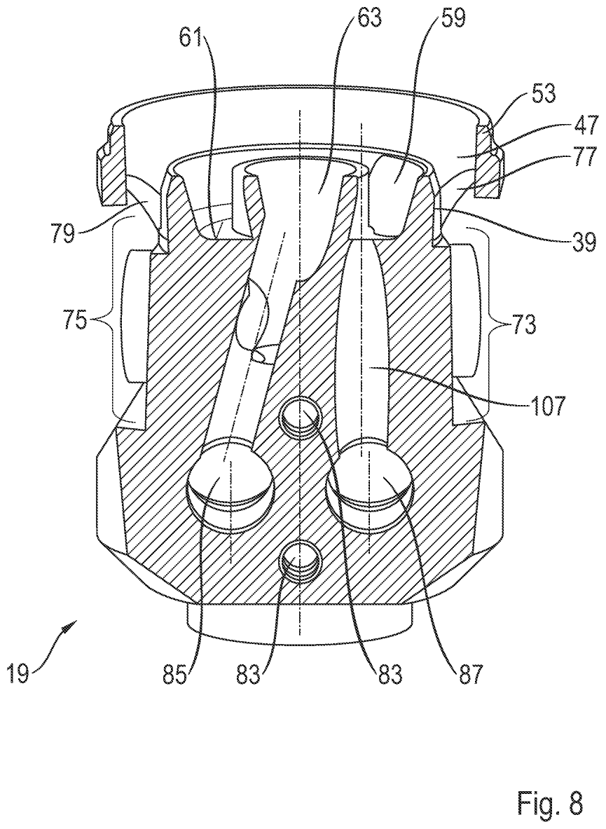

The line block 19 has a peripherally extending annular ridge 53 as part of the centering protrusion. Said annular ridge 53 axially overlaps with the container tube 41. An outer housing 55 of the damping valve devices 25; 29 is connected pressure-tight to the line block 19 in the region of the annular ridge 53 by means of a weld seam 71. Furthermore, all axial channels 63; 57 open out at the end face 61 of the line block 19. In the radially outer region between the connection region 39 for the intermediate tube 33 and the annular ridge 53, the end face 61 delimits the compensation chamber 47. With respect to the annular ridge 53, the connection region 39 for the intermediate tube 33 is axially offset toward the radial channels 49; 51 (FIGS. 6-8).

Consequently, a receiving chamber 73; 75 for the two damping valve devices 25; 29 intersects the terminal region of the compensation chamber 47. This results in passage channels 77; 79 between the compensation chamber 47 and the damping valve devices 25; 29.

A hydraulic system 81 which pumps the damping medium into the two working chambers 13; 15 by means of a pump (not shown) is connected to the line block 19. For this purpose, the line block 19 has a first and a second connection opening 85; 87, to which respective connection lines 91; 93 of the hydraulic system 81 are coupled by means of a connection block 89. The connection block 89 is mechanically connected to the line block 19 by means of at least one fastening element, in this case two threaded holes 83.

The line block 19 also has at least one shut-off valve 97; 99, which can be actuated in any way, for a volumetric flow through the connection openings 85. As can be seen in particular in FIG. 1, the at least one shut-off valve 97; 99 and the at least one adjustable damping valve device 25; 29 are arranged axially on different planes 101; 103. The two shut-off valves 97; 99 are preferably placed axially between the two damping valve devices 25; 29 and a connection element 105 fixed on the line block 19.

The hydraulic system 81 is preferably designed such that the working chambers 13; 15 are connected to the respective connection openings 85; 87. Flow through the connection openings 85; 87 is possible in both directions during the operation of the vibration damper, because a working chamber must be filled with damping medium or damping medium must be removed from said working chamber, e.g. into a reservoir (not shown) of the hydraulic system, as required.

A shut-off valve 97 and the adjustable damping valve device 25 are connected to the common fluid channel 63. The connection opening 85 for the hydraulic system 81 and the shut-off valve 97 have a common angular orientation within the vibration damper 1, so that these two components are arranged opposite each other on the line block 19. Furthermore, the longitudinal axes of the at least one shut-off valve 97; 99 and of the at least one adjustable damping valve device 25; 27 cross one another.

A fluid channel 107 to the shut-off valve 99 is oriented eccentrically with respect to the longitudinal axis of the vibration damper 1. As a result, said fluid channel 107 to the shut-off valve 99 can be produced with little machining complexity.

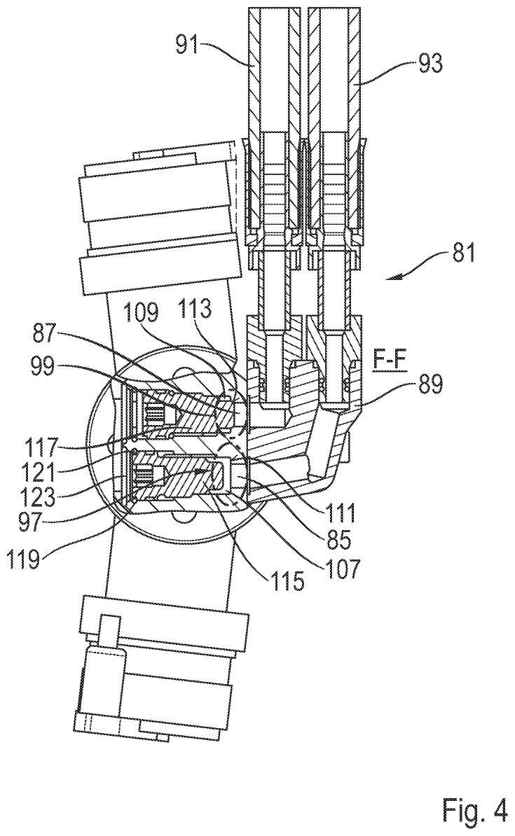

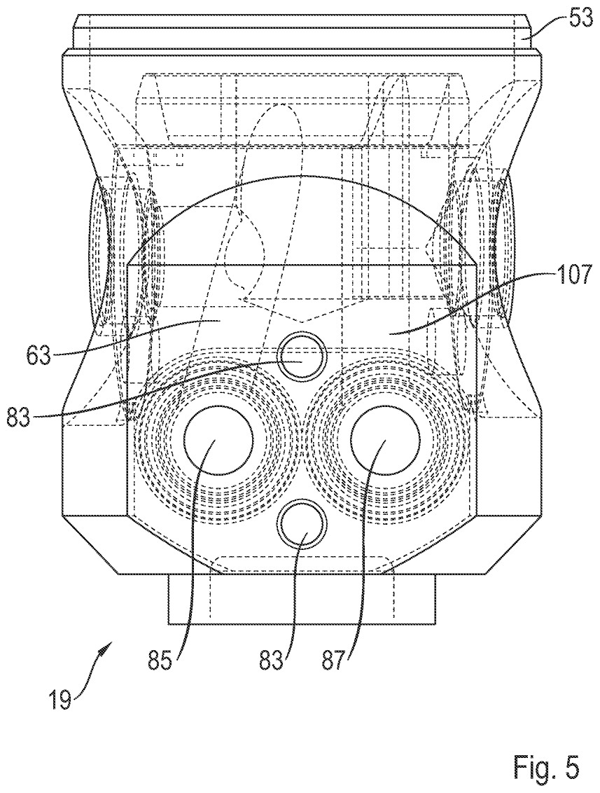

As can be seen in particular in FIG. 4, the shut-off valve 97; 99 has a connection chamber 107; 109, which is connected to the fluid line 23; 27 in the line block 19 and to the connection opening 85; 87, the connection chamber 107; 109 having a valve seat surface 111; 113 for a valve body 115; 117 of the shut-off valve. A shoulder of the connection opening 85; 87 forms the valve seat surface for the valve body. Just a small axial adjustment of the valve body 115; 117 leads to a large passage cross section at the shut-off valve 97; 99. The shut-off valve 97; 99 is oriented, within the connection chamber 107; 109, horizontally with respect to the longitudinal axis of the vibration damper 1.

Within the connection chamber 107; 109, an annular receiving groove 119 is formed behind the valve body 115; 117, said annular receiving groove holding a retaining ring 121, which forms an axial stop for the valve body 115; 117. The valve body is thus prevented from lifting off from the valve seat surface 111; 113 beyond a passage position, in particular from being pressed out of the connection chamber 107; 109 as a result of the system pressure in the vibration damper 1.

Despite the axial retaining, a receiving chamber 123 of the shut-off valve 97; 99, said receiving chamber being located behind the connection chamber 107; 109, is connected to the atmosphere. The valve body 115; 117 has, on its outer lateral surface, a groove for a sealing ring which seals off the connection chamber 107; 109 from the atmosphere. However, the valve body 115; 117 can be unscrewed out of the connection chamber 107; 109 until the sealing ring loses its sealing effect and thus air can be removed from the vibration damper 1 after connection to the hydraulic system 81.

During the assembly of the vibration damper 1, the line block 19 is welded, in the manner of a conventional bottom, to the outer container tube 41. The two shut-off valves 97; 99 are in the shut-off position, i.e. the vibration damper 1 is hermetically sealed at the line block 19. Later in the assembly process, the vibration damper is filled with damping medium and optionally a gas volume.

In a further phase of the assembly, the vibration damper 1 closed by means of the shut-off valves 97; 99 is connected to the hydraulic system 81. For this purpose, the connection block 89 is screwed to the line block 19. This assembly step can be performed at any assembly location.

Only once the shut-off valves 97; 99 are open is there also a hydraulic connection between the vibration damper 1 and the hydraulic system 81. If necessary, air can also be removed from the hydraulic system 81 by means of the shut-off valves 97; 99.

1. A vibration damper, comprising a cylinder, in which a piston on a piston rod separates a working chamber on the piston rod side from a working chamber remote from the piston rod, the two working chambers being connected, by fluid lines within a line block connected to the cylinder, to at least one adjustable damping valve device and to a hydraulic system which can be connected to at least one connection opening of the line block, wherein the line block has at least one shut-off valve, which can be actuated in any way, for a volumetric flow through the connection opening.

2. The vibration damper as claimed in claim 1, wherein the at least one shut-off valve and the at least one adjustable damping valve device are arranged axially on different planes.

3. The vibration damper as claimed in claim 1, wherein at least one shut-off valve and at least one adjustable damping valve device are connected to a common fluid channel.

4. The vibration damper as claimed in claim 1, wherein the at least one fluid channel to the shut-off valve is oriented eccentrically with respect to the longitudinal axis of the vibration damper.

5. The vibration damper as claimed in claim 1, wherein the longitudinal axes of the at least one shut-off valve and of the at least one adjustable damping valve device cross one another.

6. The vibration damper as claimed in claim 1, wherein the connection opening for the hydraulic system and the at least one shut-off valve have a common angular orientation within the vibration damper.

7. The vibration damper as claimed in claim 1 wherein the shut-off valve has a connection chamber, which is connected to the fluid line in the line block and to the connection opening, the connection chamber having a valve seat surface for a valve body of the shut-off valve.

8. The vibration damper as claimed in claim 7, wherein a receiving chamber of the shut-off valve is located behind the connection chamber and is connected to the atmosphere.

9. The vibration damper as claimed in claim 8, wherein the shut-off valve is oriented horizontally with respect to the longitudinal axis of the vibration damper.
